(19) United States
(12) Patent Application Publication
(10) Pub. No.: US 2015/0201730 A1
(43) Pub. Date: Jul. 23, 2015

(54) HAIR DRYER APPARATUS WITH NOISE REDUCING END CAP

(71) Applicant: Conair Corporation, Stamford, CT (US)

(72) Inventors: Vito James Carlucci, Stratford, CT (US); Sergio Lopes Fernandes da Costa, Danbury, CT (US)

(73) Assignee: Conair Corporation, Stamford, CT (US)

(21) Appl. No.: 14/162,363

(22) Filed: Jan. 23, 2014

(51) Int. Cl. A45D 20/04; G10K 11/16

(52) U.S. Cl. CPC A45D 20/04; G10K 11/161

(57) ABSTRACT

An apparatus for styling hair includes a housing dimensioned to be held in a hand of a user, and having an air inlet and an air outlet, a fan within the housing, a heater for heating air passing from said air inlet to said air outlet and an end cap mounted to the barrel adjacent the air inlet. The end cap includes an end cap frame defining an end cap axis and a reducer mounted within the end cap frame. The reducer is dimensioned to reduce acoustic energy. The end cap may be releasably couplable to the housing.

### BACKGROUND

1. Technical Field

The present invention relates to an apparatus for treating hair, and, in particular, relates to a hair dryer apparatus including an end cap having filter and noise reducing capabilities.

2. Description of Related Art

Hair treatment devices such as hairdryers and other appliances are known in the art. A hand held hair dryer or blower incorporates all of the functional components within the housing of the hair dryer, including, e.g., a motor, a blower and heating elements. The air is heated upon contact with the heating elements (generally electrical resistive elements) and then expelled at the opposite end in the form of a stream of hot air via the blower. The outlet end is shaped or may be fitted with removable adapters so as to shape the released stream of hot air.

The presence of the functional components within the housing increases the noise output of the hair dryer. The mechanical noise, in addition to the noise generated by the circulating airflow, is detracting to the user and the surrounding environment.

### SUMMARY

Accordingly, the present disclosure is directed to a hair dryer apparatus, which addresses the aforementioned disadvantages of conventional hair dryers. In accordance with one embodiment, the apparatus for styling hair includes a housing dimensioned to be held in a hand of a user, and having an air inlet and an air outlet, a fan within the housing, a heater for heating air passing from the air inlet to the air outlet and an end cap mounted to the barrel adjacent the air inlet. The end cap includes an end cap frame defining an end cap axis and a reducer mounted within the end cap frame. The reducer is dimensioned to reduce acoustic energy, sound and/or vibrations associated with operation of the apparatus. The end cap may be releasably couplable to the housing.

The reducer may comprise an acoustic foam. In one embodiment, the reducer is elongated and/or may be generally frusto-conically shaped. The elongated configuration may assist in reducing the intensity of the acoustic energy, vibration and/or sound by providing a greater surface area for absorption of the energy as it propagates along the reducer. The end cap frame also may be generally frusto-conically shaped. The reducer is dimensioned to extend along a majority of an axial length of the end cap frame.

In embodiments, the end cap includes a locking ring. The locking ring is dimensioned to couple with the end cap frame to facilitate securement of the reducer. The end cap may include a filter screen, which may be mounted to the end cap frame.

Other features and advantages of the hair styling apparatus will be better appreciated by the discussion hereinbelow.

### BRIEF DESCRIPTION OF THE DRAWINGS

Various embodiments of the present disclosure are described hereinbelow with references to the drawings, wherein:

FIG. 1 is a perspective view of the hair styling apparatus in the form of a blow dryer in accordance with the principles of the present disclosure illustrating the housing and the end cap mounted to the housing;

FIG. 2 is a side elevation view of the hair styling apparatus;

FIGS. 3-4 are perspective views of the end cap of the hair styling apparatus;

FIG. 5 is an exploded perspective view of the end cap of the hair styling apparatus illustrating the end cap frame, reducer, lock ring and the filter;

FIG. 6 is side elevation view of the end cap of the hair styling apparatus;

FIG. 7 is a side cross-sectional view of the end cap of the hair styling apparatus;

FIG. 8 is a cross-sectional illustrating one mechanism for releasably mounting the end cap to the barrel; and

FIG. 9 is a side cross-sectional view of the end cap with the lock ring and the filter removed illustrating absorption and reflection of the acoustic energy within the reducer.

### DETAILED DESCRIPTION OF THE EMBODIMENTS

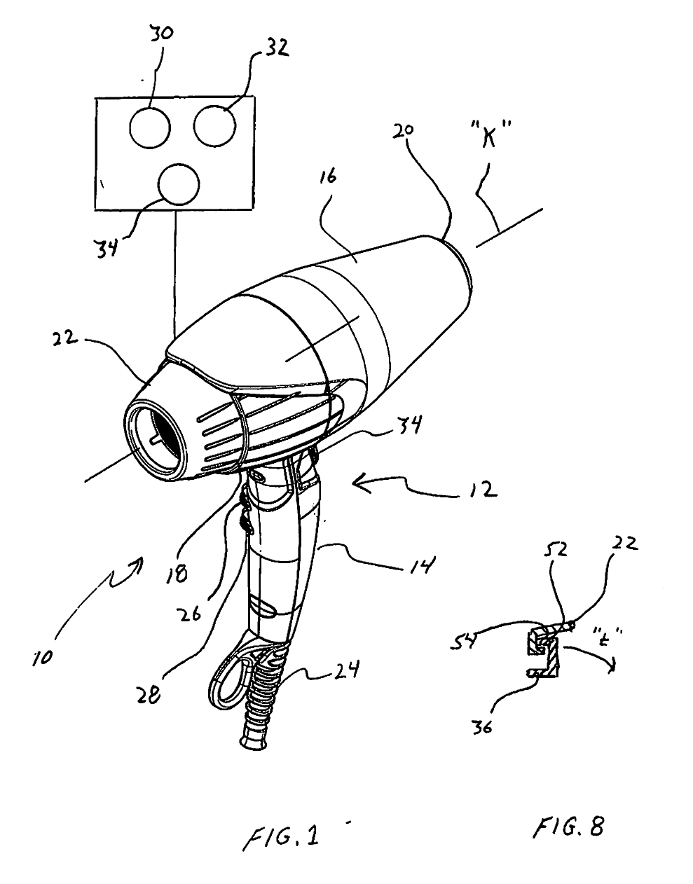

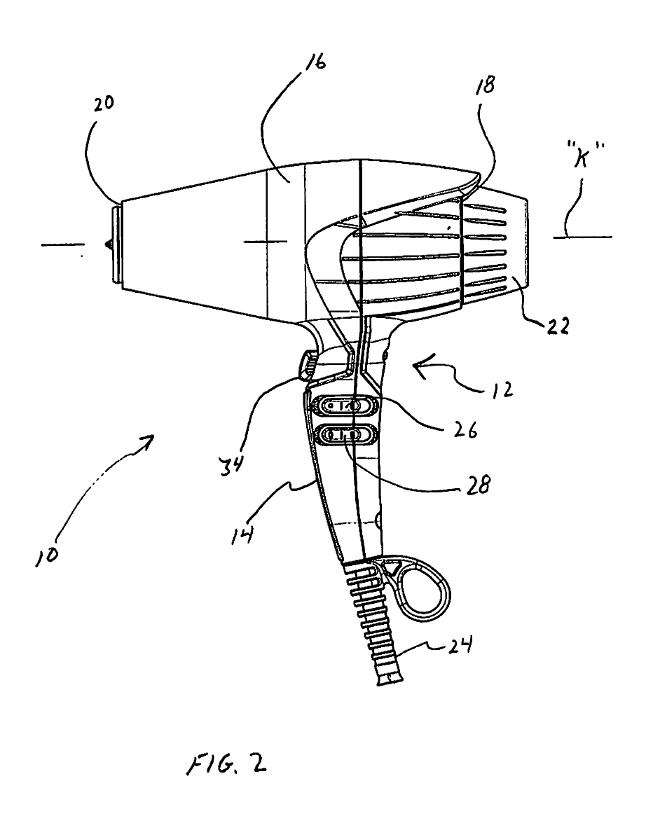

FIG. 1 is a perspective view of one illustrative embodiment incorporating the features of the present disclosure and, in the form of a hair styling apparatus 10. The hair styling apparatus 10 includes a housing 12 having a handle frame or hand grip 14 and a barrel 16 depending from the handle frame 14. The hand grip 14 and the barrel 16 may define a pistol configuration. Other configurations including linear are also envisioned. The barrel 16 defines a longitudinal barrel axis “k” and has an air inlet end 18 and an air outlet end 20. The apparatus 10 further includes an end cap 22, which is coupled to the handle frame 12. Specifically, the end cap 22 is mounted adjacent the air inlet end 18 of the barrel 14 in longitudinal opposed relation to the air outlet end 20. A power lead 24 extends from the handle frame 14 to power the apparatus.

The handle frame 12 includes a plurality of switches or control elements for controlling the functioning of the apparatus 10. The switches or control elements may include a master switch such as a power on/off switch and/or at least one or two or more control elements or switches 26, 28. The first control element 26 may control the resistor or heater elements 30 which heat the air entering the air inlet end 18 and emitted by the air outlet end 20. For example, the first control element 26 may be in electrical communication with a rheostat or variable resistor to control the heat setting and level of heat applied to the air. Multiple heat settings, e.g. three, are contemplated. The second control element 28 may adjust the speed of the airflow leaving the blower or fan 32, e.g., by varying the rotational speed of the blower 32 between a multiple of speed settings, e.g., two settings. The hair styling apparatus 10 may include a button or switch 34, which is selectively toggled to deactivate the heater elements 30 to provide a prolonged blast of cold air to the hair, i.e., a cold shot button 34. Other switches or control elements for controlling auxiliary functioning of the apparatus 10 are also envisioned. The resistor or heater elements 30, blower or fan 32, and the motor 34 for operating the fan 32 are depicted schematically in FIG. 1.

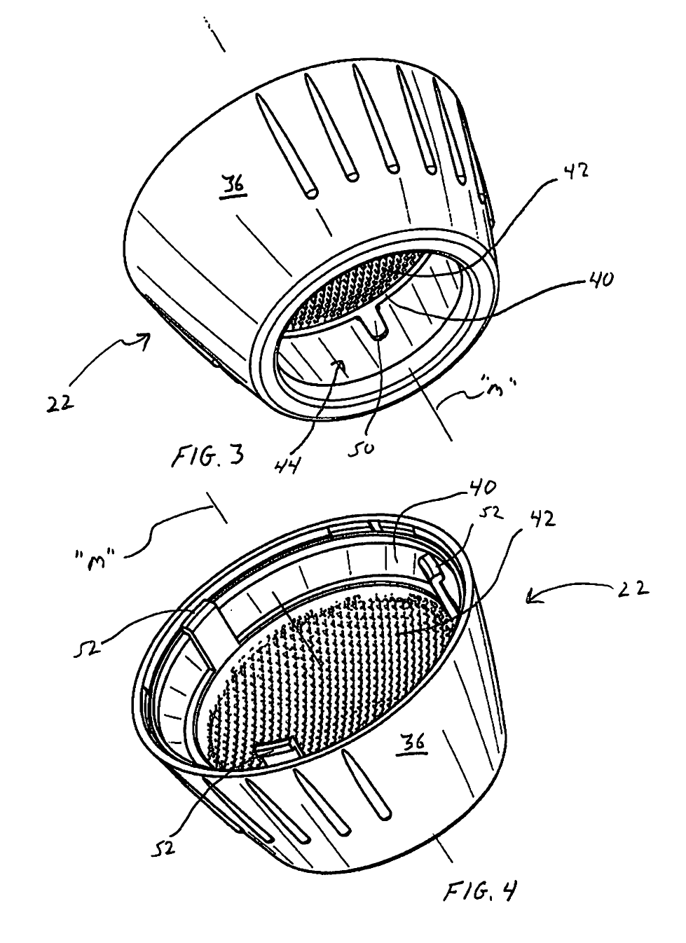

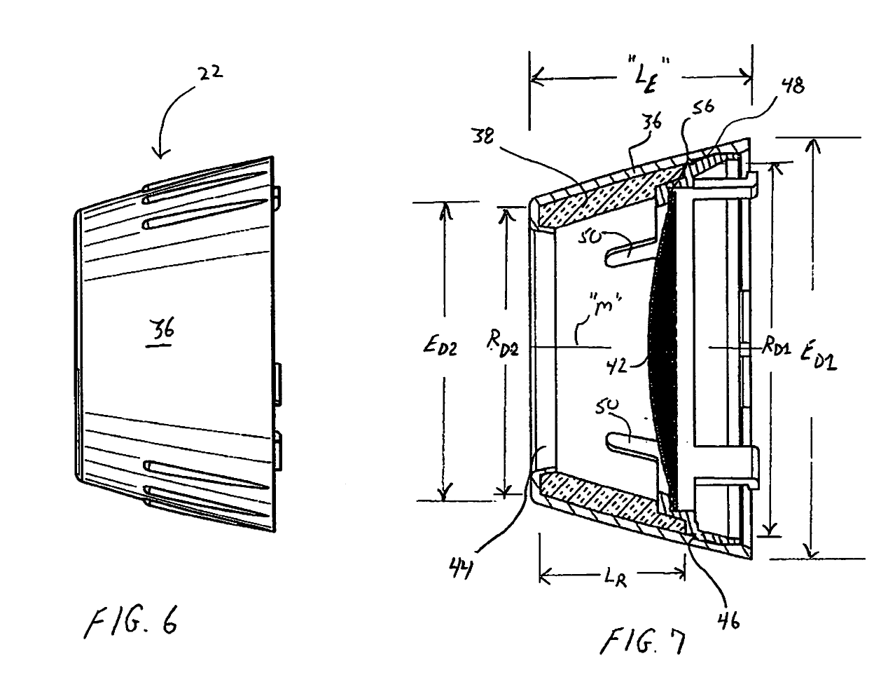

Referring now to FIGS. 3-7, the end cap 22 connected to the air inlet end 18 of the barrel 16 will be discussed. The end cap 22 may include four components, namely, an end cap frame 36 defining an end cap axis “m”, a reducer 38, a lock ring 40 and a filter 42. The end cap frame 36 may be generally conical in configuration defining an elongated body, which reduces in cross-section away from the air inlet end 18. The longitudinal length “L_{E}” of the end cap frame 32 ranges from about 35 mm. The diameter of the end cap frame 32 is about 66 millimeters (mm) (“E_{D1}”) and reduces to about 52 millimeters (mm) (“E_{D2}”). The end cap frame 36 defines an air intake opening 44 for reception of ambient air and is in fluid communication with the air inlet end 18 of the barrel 16 to convey the ambient air.

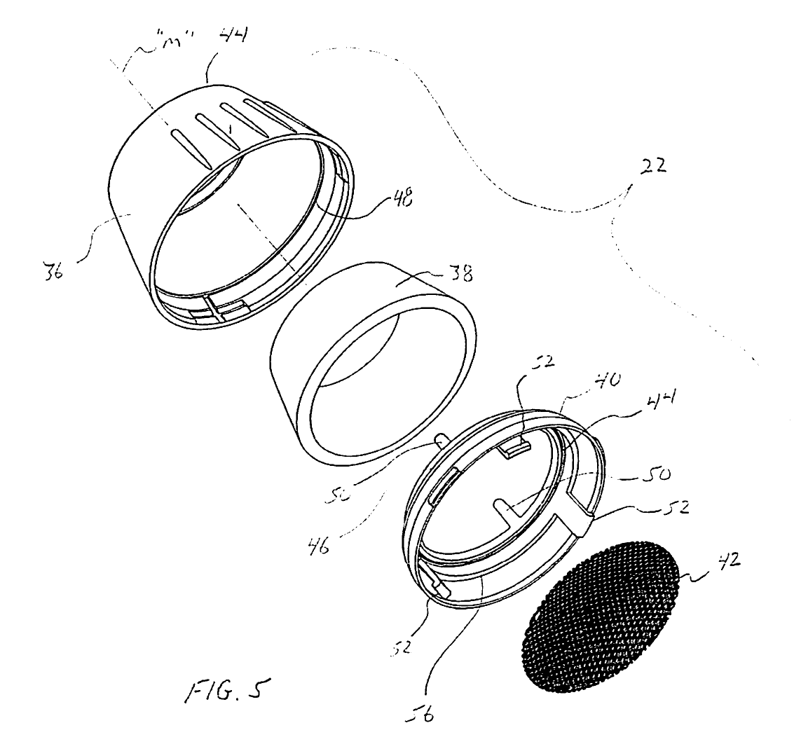

As best depicted in FIGS. 5 and 7, the reducer 38 is also frusto-conical in configuration, and may generally correspond in dimension to the internal boundary of the end cap frame 36. The reducer 38 defines a longitudinal length “L_{R}” extending more than half the length, e.g., a majority of the length, of the end cap frame 36. In embodiments, the length of the reducer 38 is about 59.4 millimeters (mm) adjacent the air inlet end 18 (“R_{D1}”) of the barrel 16, and reduces to about 49 millimeters (mm), remote from the barrel 16 (“R_{D2}”). Other dimensions of the variations of the end cap 22 and the reducer 38 are also envisioned while maintaining the general relative geometry and tapers of the components.

The reducer 38 is dimensioned to reduce acoustic energy, sound and/or vibration associated with operation of the apparatus 10. In embodiments, the reducer 38 includes a noise and/or vibration reducing material such as an acoustic foam ring. The foam ring is adapted to remove residual sound and vibrations within the end cap frame 32. For example, the foam ring is characterized by having very low reflecting capabilities coupled with high absorption capabilities to absorb acoustic or sound energy. Suitable acoustic foam materials include any commercially-available acoustic open cell foam. In addition, the elongated axial length of the reducer 38 increases the surface area to which the acoustic, sound and/or vibration waves are exposed during propagation through the end cap 36 thereby further facilitating absorption within the foam of the reducer 38. In addition, the conical shape of the reducer 38 may further facilitate noise reduction by increasing the distance of travel of the propagating waves not absorbed by the foam of the reducer 38, including, longitudinal and radial relative components of direction, relative to the end cap axis “m”.

The reducer 38 may be mounted within the end cap frame 32 through any conventional arrangement. In one embodiment, the lock ring 40 is assembled within the end cap frame 36 in a manner securing the reducer 38 between the components. For example, the lock ring 40 may include an inner annular ledge 46 which is received within a corresponding annular locking recess 48 of the end cap frame 36 in snap relation therewith thereby securing the lock ring 40 to the end cap frame 36 with the periphery of the reducer 38 disposed therebetween. Other arrangements are envisioned including with the use of cements, adhesives or the like.

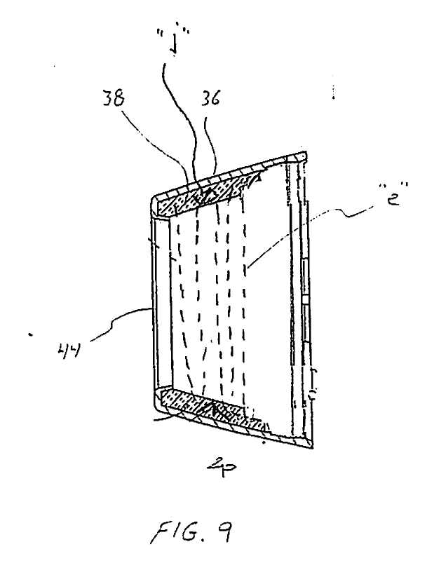

The lock ring 40 further includes at least two spacers 50 which engage the inner surface of the reducer 38 and at least three locking detents 52. The spacers maintain 50 the positioning of the reducer 38 relative to, or against, the inner wall of the end cap frame 36 to, e.g., prevent migration relative to the end cap frame 36. The locking detents 52 engage a corresponding annular recess 54 within the barrel 16 adjacent the air inlet end 18 to secure the end cap 22 to the barrel 16 in snap relation therewith. FIG. 8 is a partial view in cross-section illustrating engagement of one locking detent 52 with the edge defining the inner annular locking ledge 54 within the barrel 16. The lock ring 40 further includes an internal annular shelf 56, which receives the periphery of the filter 42 thereby securing the filter 42 relative to the end cap 22. The filter 42 may be any known screen style filter, which traps lint, dust and hair or the like. In one embodiment, the filter 42 is removable from the internal annular shelf 56 to be cleaned and/or replaced.

The end cap 22 is selectively releasable relative to the barrel 16. For example, removal of the end cap 22 may be affected through engagement of the end cap frame 36, and directing an outward force away from the barrel 16 causing the locking detents 52 to temporarily be displaced in the direction of inward arrow “t” (FIG. 8) to permit release from the annular recess 54 within the barrel 16. The end cap 22 may be mounted to the barrel 16 by advancing the end cap frame 36 toward the air inlet end 18 of the barrel 16 whereby the locking detents 52 deflect inwardly whereby upon encountering the locking ledge 54 return outwardly to secure the end cap frame 36 relative to the barrel 16. The filter 42 may be selectively released from the end cap frame 36, i.e., with the end cap 22 removed from the barrel 16, for cleaning and/or replacement.

During use, the apparatus 10 is activated. Air is drawn within the into the air intake opening 44 of the end cap 22. As depicted in FIG. 9, acoustic energy or waveforms, noise and/or vibration “e” associated with operation of the motor and fan, in addition to noise generated by the intake of air the air intake is minimized, reduced and/or absorbed by the reducer 38. In FIG. 9, the lock ring 40 and the filter 42 are removed for clarity. The acoustic foam of the reducer 38 absorbs at least some or most of the acoustic energy or at least partially reflects the acoustic sound waves. As hereinabove discussed, the elongated axial length, e.g., frusto-conical shape, of the reducer 38 increases the surface area upon which the acoustic, sound or vibration waves contacts thereby further facilitating absorption within the foam of the reducer 38. Any residual energy waves not absorbed by the reducer 38 is, in effect, dampened due to the open cell and soft surface of the foam thereby further facilitating noise reduction.

Although the illustrative embodiments of the present disclosure have been described herein with reference to the accompanying drawings, the above description, disclosure, and figures should not be construed as limiting, but merely as exemplifications of particular embodiments. It is to be understood, therefore, that the disclosure is not limited to those precise embodiments, and that various other changes and modifications may be effected therein by one skilled in the art without departing from the scope or spirit of the disclosure.

What is claimed is:

1. An apparatus for styling hair, which comprises:
a housing dimensioned to be held in a hand of a user, said housing having an air inlet and an air outlet;
a fan within said housing;
a heater for heating air passing from said air inlet to said air outlet; and
an end cap mounted to said barrel adjacent said air inlet, said end cap including an end cap frame defining an end cap axis and a reducer mounted within said end cap frame, said reducer dimensioned to reduce acoustic energy.

2. The apparatus according to claim 1 wherein said end cap is releasably couplable to the housing.

3. The apparatus according to claim 1 wherein said reducer comprises acoustic foam.

4. The apparatus according to claim 3 wherein said reducer is elongated.

5. The apparatus according to claim 4 wherein said reducer is generally frusto-conically shaped.

6. The apparatus according to claim 5 wherein said end cap frame is generally frusto-conically shaped.

7. The apparatus according to claim 6 wherein said reducer is dimensioned to extend along a majority of an axial length of said end cap frame.

8. The apparatus according to claim 2 wherein said end cap includes a locking ring, said locking ring dimensioned to couple with said end cap frame to facilitate securement of said reducer.

9. The apparatus according to claim 8 wherein said end cap includes a filter screen.

10. The apparatus according to claim 9 wherein said filter screen is releasably mounted to said locking ring.
